(19) United States
(12) Patent Application Publication
(10) Pub. No.: US 2025/0014426 A1
(43) Pub. Date: Jan. 9, 2025

(54) WAGERING SYSTEMS AND METHODS WITH CRITERIA-BASED TOTALIZER SELECTION, AND TOTALIZER SELECTOR DEVICE

(71) Applicant: Castle Island IP Holding LLC, Charlottesville, VA (US)

(72) Inventor: Joshua LARSON, Charlottesville, VA (US)

(21) Appl. No.: 18/761,849

(22) Filed: Jul. 2, 2024

Related U.S. Application Data
(60) Provisional application No. 63/524,798, filed on Jul. 3, 2023.

(51) Int. Cl. G07F 17/32

(52) U.S. Cl. CPC G07F 17/3258; G07F 17/323; G07F 17/3237; G07F 17/3288

(57) ABSTRACT

A totalizer selector for a parimutuel or pot-based wagering system is provided. The wagering system includes first totalizer configured to perform parimutuel calculations according to a first pool, a second totalizer configured to perform parimutuel calculations according to a second pool, and one or more wagering terminals. The totalizer is configured to communicate with the one or more wagering terminals, the first totalizer, the second totalizer, or another device having information regarding criteria to be used in totalizer selection, the totalizer selector is configured to apply the one or more rules to a criteria and select the first totalizer or the second totalizer for a wagering event presented by the one or more wagering terminal, and output an indication of the selected first totalizer or the second totalizer to the one or more wagering terminals, the first totalizer, or the second totalizer.

### CROSS-REFERENCE TO RELATED APPLICATIONS

This application further claims the benefit of and priority to U.S. Provisional Patent Application Ser. No. 63/524,798 filed on Jul. 3, 2023, which application is expressly incorporated herein by reference.

### BACKGROUND

The present disclosure relates generally to a wagering system and particularly to a parimutuel wagering system featuring two or more totalizers that calculate wagers, odds, payouts, and other features that are the subject of one or more wagers.

Parimutuel betting or pool betting is a betting system in which all bets of a particular type are placed together in a pool; taxes and the “house-take” or “vigorish” are deducted, and payoff odds are calculated by sharing the pool among all winning bets. A tote board (or totalisator/totalizator/totalizer) is a numeric or alphanumeric display used to convey information, typically at a racetrack or similar event. Pot-based wagering may also use a totalizer, or a device that performs totalizing-type calculations.

The term “tote board” comes from the colloquialism for “totalizator” “tote” (or “totalisator”), or “totalizer” the name for the automated system which runs parimutuel betting, calculating payoff odds, displaying them, and producing tickets based on incoming bets, which will be referred to hereinafter generally as a “totalizer” or “tote”. Parimutuel systems have used totalizator boards since the 1860s and they were often housed in substantial buildings.

Today with calculations and internet communications so readily available and prominent, parimutuel betting has reached a wider audience and is becoming increasingly popular. The calculations performed by a totalizer have become increasingly complex, requiring more powerful computers to carry out the calculations.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Embodiments of the present disclosure are directed to a parimutuel wagering system including a first totalizer, a second totalizer, and a totalizer selector coupled to the first totalizer and to the second totalizer. The totalizer selector comprising a memory storing one or more criteria. The totalizer selector applies the one or more criteria to one or more wagers received. The wagers pertain to a game for which the first totalizer and second totalizer are configured to perform calculations for the parimutuel wagering system.

Further embodiments of the present disclosure are directed to a computer-readable medium for a parimutuel wagering system comprising storage containing instructions that, when executed by a processor, cause the parimutuel wagering system to perform a method. The method includes receiving one or more wagers from one or more bettors and receiving one or more criteria pertaining to totalizer selection. The parimutuel wagering system comprises two or more totalizers configured to perform parimutuel wagering calculations based on the wagers received from the bettors, and based on a game that is the subject of the parimutuel wagering system. The method also includes applying the criteria to the wagers to select a totalizer from among the two or more totalizers of the parimutuel wagering system to which the wagers are assigned, distributing the wagers to a corresponding totalizer based, at least in part, upon the criteria, monitoring the game, and calculating an outcome of the wagers with respect to the game. The method also includes delivering a payout corresponding to the outcomes and the wagers according to the calculations of a totalizer.

Still other embodiments of the present disclosure are directed to a parimutuel wagering system including a processor and memory storing instructions that, when executed by the processor cause the parimutuel wagering system to perform steps. The steps include receiving a plurality of wagers on a game, storing one or more criteria for the wagers, the criteria determining a selection of a totalizer from among two or more totalizers configured to calculate the outcome of the game and the wagers, and applying the criteria to the plurality of wagers. The steps also include distributing the wagers to a corresponding totalizer according to the criteria and calculating an outcome for each wager at the corresponding totalizer.

Embodiments of the present disclosure are directed to a parimutuel c wagering system including a first totalizer configured to perform parimutuel calculations or parimutuel-like calculations according to a first pool, and a second totalizer configured to perform parimutuel calculations according to a second pool. The wagering system also includes one or more wagering terminals and a totalizer selector configured to communicate with the one or more wagering terminals, the first totalizer, or the second totalizer. The totalizer selector includes a memory storing one or more rules, wherein the totalizer selector is configured to apply the one or more rules to a criterion. Based on the wagering criteria and one or more rules, the totalizer selector selects the first totalizer or the second totalizer for a wagering event presented by the one or more wagering terminal, and outputs an indication of the selected first totalizer or the second totalizer to the one or more wagering terminals, the first totalizer, or the second totalizer.

Yet other embodiments of the present disclosure are directed to a computer-readable medium for a parimutuel wagering system comprising storage containing instructions that, when executed by a processor, cause the parimutuel wagering system to perform a method including receiving one or more wagers from one or more bettors and receiving one or more criteria pertaining to totalizer selection. The parimutuel wagering system comprises two or more totalizers configured to perform parimutuel wagering calculations based on the wagers received from the bettors, and based on a game that is the subject of the parimutuel wagering system. The method also includes applying the criteria to the wagers to select a totalizer from among the two or more totalizers of the parimutuel wagering system to which the wagers are assigned, and distributing the wagers to a corresponding totalizer based, at least in part, upon the criteria. The method further includes monitoring the game, calculating an outcome of the wagers with respect to the game, and delivering a payout corresponding to the outcomes and the wagers according to the calculations of a totalizer.

Further embodiments of the present disclosure are directed to a parimutuel wagering system having a processor and a memory storing steps, including receiving a plurality of wagers on a game and storing one or more criteria for the wagers. The criteria determine a selection of a totalizer from among two or more totalizers configured to calculate the outcome of the game and the wagers and applying the criteria to the plurality of wagers. The method also includes distributing the wagers to a corresponding totalizer according to the criteria and calculating an outcome for each wager at the corresponding totalizer.

Still other embodiments of the present disclosure are directed to a parimutuel wagering method including communicating with one or more totalizers, wherein the totalizers are configured to perform calculations for one or more parimutuel games, each having a pool and wagers received from bettors, storing one or more criteria for assigning wagers to the totalizers, and receiving a wager. The method also includes assigning the wager to a totalizer selected based, at least in part, upon the criteria.

Further embodiments of the present disclosure are directed to a wagering terminal for a parimutuel game. The wagering terminal includes a display interface configured to display information to a bettor, the information relating to the parimutuel game, wagers on the parimutuel game, and outcomes of the parimutuel game. The wagering terminal also includes an input interface configured to receive inputs from the bettor including a selection of a game and a wager on the game, and an electronic communication interface configured to transmit the information and the inputs to and from the wagering terminal to a totalizer selector that is in communication with one or more totalizers that are configured to perform calculations for the parimutuel game.

Other embodiments of the present disclosure are directed to a totalizer for a parimutuel wagering system including a processor and a memory for carrying out a method including communicating electronically with a game, the outcome of which is the subject of wagers, communicating electronically with a totalizer selector configured to assign wagers on the game to the totalizer based, at least in part, upon criteria, and receiving one or more wagers on the game from the totalizer selector, that are assigned to the totalizer, the wagers satisfying the criteria as determined by the totalizer selector. The method also includes performing parimutuel calculations on the game and the wagers and transmitting an outcome of the wagers.

### BRIEF DESCRIPTION OF THE SEVERAL VIEWS OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 is a block diagram of a related parimutuel wagering system.

FIG. 2 is a block diagram of a multi-totalizer parimutuel wagering system according to embodiments of the present disclosure.

FIG. 3 is a schematic depiction of the criteria used to distribute wagers to different totalizers according to embodiments of the present disclosure.

FIG. 4 is a flow diagram showing a method for the parimutuel wagering system according to embodiments of the present disclosure.

FIG. 5 is a flow diagram showing a method for tracking a better profile according to embodiments of the present disclosure.

FIG. 6 is a block diagram of a parimutuel wagering system according to embodiments of the present disclosure.

### DETAILED DESCRIPTION

The present disclosure provides various examples and embodiments of wagering systems that use totalizers, also known as totes, tote boards, or totalizators, to perform calculations related to wagers based on a game or event. The system includes two or more totalizers which can perform calculations for a plurality of wagers on a game or event. The system also includes a totalizer selector that stores certain criteria and applies the criteria to incoming wagers and distributes the wagers to the different totalizers based upon the criteria. The criteria can include game characteristics that pertain to the game or event that is the subject matter upon which the wagers are placed. The criteria can include wager characteristics, bettor characteristics (both individually or collectively), or totalizer characteristics. The system can perform this selection without notifying the bettors of the selection of totalizer to achieve a seamless experience for the better.

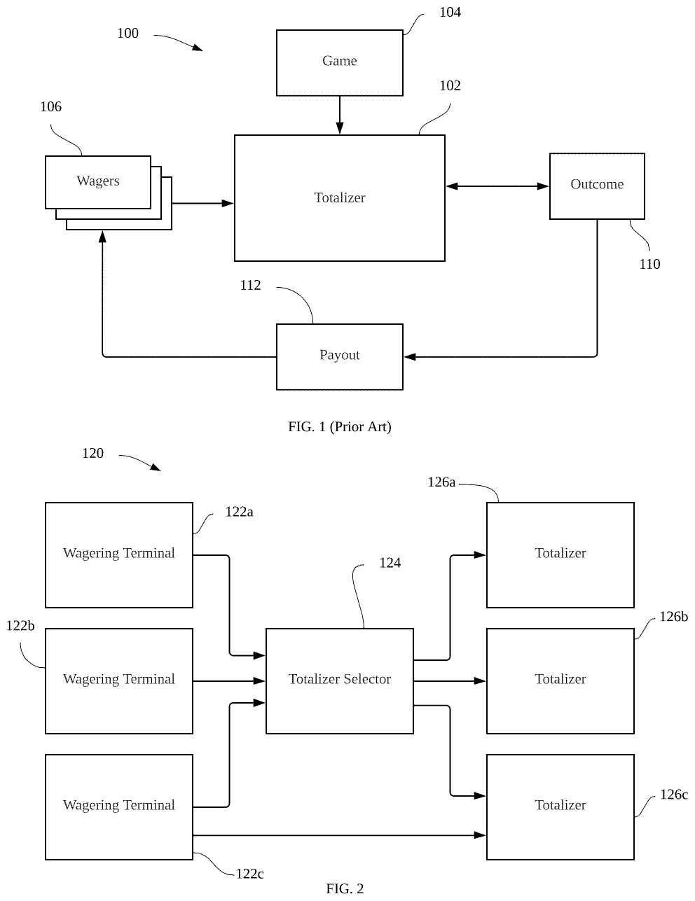

FIG. 1 is a block diagram of a related parimutuel or post-based wagering system 100. The system 100 includes a totalizer 102 that automatically performs calculations to add up wagers in a parimutuel wagering system. The whole of the pot (the stakes on all competitors) is divided pro rata to the stakes placed on the winning competitor and those tickets are paid out. In some embodiments the totalizer 102 implements a system of starting price (SP) betting. The totalizer 102 is in communication with a game 104 which can be a horse race, a dog race, or any other game that can be the subject of a wager in a parimutuel system. The totalizer 102 receives wagers 106 from a plurality of individuals who choose a competitor in the game 104, select a finishing result (winning, placing, in the money, etc.), and submit funds as part of the wager. The plurality of wagers 106 can be received, stored, and calculated by the totalizer 102. The system 100 can be operated by an entity or group of entities who controls one or more aspects of the system including operating the totalizer 102, controls the finances, the communication systems, and monitors the game 104 for an outcome that is the subject of the wagers.

When the game 104 reaches an outcome 110, the result is published and individual bettors can be notified of the result. A payout 112 can be made to the bettors who placed the wagers 106 on the game 104. A benefit of such a parimutuel system 100 is that the operator of the system receives a “take” regardless of the outcome.

The system 100 can be implemented using computing devices that are connected electronically such as through the internet or over another local communication network such as a local area network. The system 100 can be implemented over a cellular network or any other suitable electronic communication network. The totalizer 102 can be a general purpose computer or server or plurality of servers that work together to perform the calculations for the parimutuel wagering system. The wagers 106 can be received electronically through remote electronic devices such as smart phones, computers, laptops, tablets, or any other electronic device that communicates electronically. In some embodiments the system 100 is in a physical location and betters can approach a desk and manually place wagers 106 that are then input to the system 100.

FIG. 2 is a block diagram of a multi-totalizer parimutuel or post-based wagering system 120 according to embodiments of the present disclosure. The system 120 includes one or more wagering terminals 122a, 122b, and 122c (collectively, wagering terminals 122) that are configured to take wagers on various events or games. The subject matter of the wagers can be virtually any conceivable event. The wagering terminals 122 can be physical kiosks having a screen, an input device such as a keyboard, mouse, touch screen, or other suitable input system. The wagering terminals may be housed in a wagering facility or may be stand-alone units. In some embodiments the wagering terminals are operated as software running on a device owned by individuals such as smart phones, tablets, laptops, etc. The wagering terminal may be an app on such a device, or other software such as programs for Microsoft Windows, Apple IOs, or LINUX.

The system 120 also includes a totalizer selector 124 that is in communication with the one or more wagering terminals 122 to exchange information including wagers, wagering parameters, media content, rules, and selection criteria. The system 120 also includes one or more totalizers 126a, 126b, and 126c (collectively, totalizers 126). The totalizers 126 are in communication with the totalizer selector 124. In some embodiments a wagering terminal 122c is in direct communication with a totalizer 126c.

The totalizer selector 124 receives communication including from from or about the wagering terminals 122, or wagering games provided on the wagering terminals, and, based at least in part upon certain rules and the received information, assigns the wagering terminal to one or more of the totalizers 126. The basis for assigning each wager to a certain totalizer can be a feature of the wagering terminals, a feature of the wagers, a feature of a specific game provided by the wagering terminal, a feature of the totalizer, a feature of the math type of the wager and game, or a feature of the bettor.

The system 120 can be distributed in several ways. For example, the wagering terminals 122 can be housed in the same facility as the totalizer selector 124 and the totalizers 126. Or the wagering terminals 122 can be distributed in remote locations, and the totalizer selector 124 and totalizers 126 can be housed in the same facility. Or the wagering terminals 122, totalizer selector 124, and totalizers 126 can each be housed in separate facilities. In some embodiments the totalizer selector 124 and one or more of the totalizers 126 can be operated by the same computing device, which may be a single or multi-processor computing device. In addition to these envisioned variations, different entities may own and operate one or more components of the system 120.

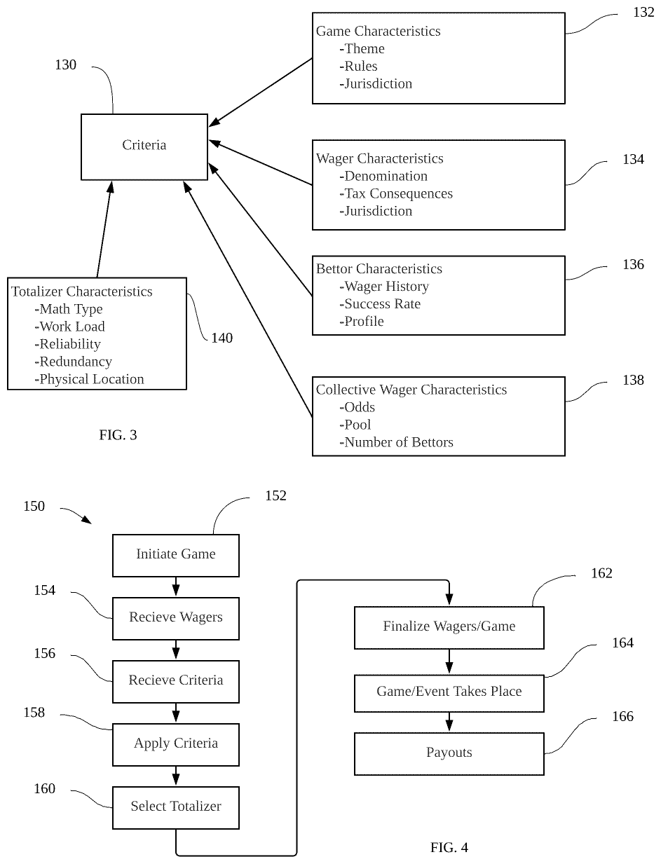

FIG. 3 is a schematic depiction of the criteria 130 used to distribute wagers or assign a wagering terminal to different totalizers based at least in part on received communication including information about the specific wagering terminal or wagering game provided on the wagering terminal, according to embodiments of the present disclosure. The criterial 130 may include characteristics 125 of or about the wagering terminal 122. For example, the criterial may include the physical location of the wagering terminal, physical location within the wagering environment, location within a floor area of the wagering environment, online location of the terminal, or if communicating with the totalizer selector or totalizer remotely, the location of the wagering terminal within a geographic region, such as a state or city. The wagering terminal characteristics 125 may also include information of the selected game presented by the wagering terminal or the game selected by the user, bettor, or player. The wagering terminal characteristics may also include an ID of the wagering terminal, such as serial number assigned to the wagering terminal. The characteristics 125 may also include the make, type, model, or manufacturer of the wagering terminal, or ownership information of the wagering terminal, or information of the servicer of the terminal. The characteristics 125 may also include legal information relating to the wagering terminal, such as information based on the licensor or licensee of the wagering terminal, or licensor or licensee information relating to a game or wagering event provided by the wagering terminal. The characteristics 125 may also include information relating to the network to which the wagering terminal is connected to, or tenant information of the wagering terminal. The wagering terminal characteristics 125 may include status information of the current operation of the terminal, such as the data connection provided to or use by the wagering terminal. Further, the criteria may be based on static, current, or dynamics characteristics of the network or system in which the wagering terminal is provided and operates. For example, the criteria may be based on the network connection or data connection available to or used by the wagering terminal or the totalizer, or both.

As shown in FIG. 3, the criteria 130 can include game characteristics 132 which are aspects of the game itself that is the subject of the parimutuel or post-based wagering system 120. One example is the theme of the game 104. The game 104 may be presented as a horse race from previous time known as Historical Horce Racing (HHR). Other games 104 may have different themes, such as a futuristic race between rockets in space. In some embodiments the rockets in space can be based on a historical race but are presented differently at different wagering terminals in different wagering establishments. Other themes include different types of parimutuel wagering games such as a contest in a reality TV show. The themes that differentiate these different games can be used to select a corresponding tote 124. For example, all HHR wagers can be directed to a first tote 124a, all space rocket wagers can be directed to a second tote 124b, and all reality TV show contests are directed to a tote 124c.

Another game characteristic is the rules of the game. Each game has a set of rules that may be based on the actual event, such as in the case of a horse race, there are rules regarding jockey behavior, starting times, length of the race, etc. Other games will have different rules as well. The rules can be a criterion for selecting a tote 124. Games with similar rules may be directed to the same totalizer.

Another game characteristic can be jurisdiction. Wagering is legal in some jurisdictions, regulated in others, and prohibited in still others. The wagers from these different jurisdictions can be used as a criteria for selecting a totalizer. In some embodiments the physical location of the wager, and the totalizer, can vary and can be the subject of regulations or laws in various jurisdictions. The system 120 allows the use of these criteria to ensure that the laws and regulations in each jurisdiction are followed rigorously.

In some embodiments the criteria 130 includes wager characteristics 134. One example of a wager characteristic is a denomination of a wager, such as a $1, $5, $10, etc. wager. Wagers can be grouped by denomination and sent to a totalizer dedicated to wagers for the game of that denomination. The denominations can be any arbitrary denomination. The wagers of a given denomination can be sent to a totalizer for that denomination. In some embodiments the wagers can be grouped into ranges of denomination, such as wagers up to $10, between $10-$100, etc.

Another wager characteristic is tax consequences related to a wager. In various jurisdictions, the tax implications for wagering are different, and these differences can be used to group wagers and direct the wagers to a totalizer for jurisdictions or groups of jurisdictions that have similar tax consequences. Jurisdiction can be a wager characteristic, similar to the game characteristic described above. The laws and regulations in various jurisdictions can apply to the bettor as well as the provider. These jurisdictional differences can be a criterion used to direct wagers to a dedicated totalizer.

Another type of criterion can be bettor characteristics 136. The system 120 can require individuals to log in to the system to place wagers and can track individual betting patterns and habits pertaining to the individual placing the wager. For example, the system 120 can differentiate between frequent bettors and infrequent bettors. Between high-value bettors, mid-value bettors, and low-value bettors. Wagers from these bettors can be grouped and directed to a totalizer pertaining thereto. The system 120 can establish a profile for each bettor that updates with each wager or each interaction with a wagering system 120, such that the system 120 has an educated idea of how and on what the bettor will wager. These criteria can be used to group wagers to a totalizer better suited to individual bettors.

Another type of criterion is collective wager characteristics 138 that pertain to a group of bettors and wagers. In one embodiment the system can group wagers together in the order received, and can group the first one hundred wagers and direct them to a totalizer. The next 100 that come in are directed to a second totalizer, etc. The number of wagers per totalizer can vary based on computing power of the totalizer, or can be arbitrary. In some embodiments a totalizer can be filled with wagers that sum to a predetermined limit. For example, once the total amount of money on the line from any number of wagers is placed, the totalizer can be closed and any other wagers coming in are directed to a next totalizer. There may be safeguards in place such as a minimum number of bettors for a given totalizer.

In some embodiments wagers can be grouped for a totalizer based on which competitors and outcomes are being chosen. A totalizer can be initiated to calculate wagers based on a number of outcomes, and to ensure fairness, a selection of the wagers can be made based on a distribution of choices. For example, from among a group of wagers, a subset of the wagers can be selected such that the wagers in the totalizer are representative of the competitors. The totalizer can maintain a statistical distribution of outcomes, and once a certain number of wagers is received that is distributed among the various outcomes, competitors, etc., those wagers are grouped and directed to a totalizer.

In still other embodiments the criteria can be totalizer characteristics 140. The totalizer characteristics can include practical considerations for the physical and operational capacity of the computing devices that comprise the totalizers. Examples include math type, workload, reliability, redundancy, and physical location of the totalizers. The math type criteria are related to how the calculations in the totalizer are carried out, and to how the funds are distributed within the pool, to the winners, and to the operator as a “take” or a “vigorish” (a.k.a. “vig”). For example, some totalizers are run on a percentage basis, where the funds from all wagers are pooled together, and the take is a percentage of the total pool. In other embodiments, the take is constrained with a minimum or a maximum take. In other embodiments still the take can be a complex formula including breakpoints and different rates etc. There may be circumstances where the size of the pool determines how the winnings are calculated and how the take is calculated. These are the math type criteria used as totalizer characteristics that can be used as a basis for assigning a wager to a certain totalizer.

In some embodiments the criteria for determining a totalizer for a given wager can be based on the grouping of these components. For example, a totalizer can be assigned to receive wagers from a certain wagering terminal or group of wagering terminals. In other embodiments, the criteria can be based on the game that is the subject matter of the wagers. The wagers for a historical horse racing game, for example, can be assigned to a dedicated totalizer for that game. The same can be true for Bingo, Sports, or any other game. In yet other embodiments, the wager itself can be the basis for assigning the wagers to the totalizers. In any case the criteria used to determine which totalizer applies to which wager can be based on a predetermined rationale, expressed in terms of a series of rules or criteria, resulting in a more efficient, more coherent and less error prone system than a single totalizer making a multitude of diverse calculations.

Computation creates wear and tear on computing systems, and with complex calculations such as those performed by the totalizers can represent a significant burden on the totalizers that can be a selection criterion for the totalizers.

The criteria can be used individually or in combination. In some embodiments the criteria can have a weighted average such that certain criteria are more influential to the selection of totalizer than others. In some embodiments each criteria can have a weight, and the weights can be multiplied together so that if two or more of the criteria that are heavily weighted are both present, the product of their weights produces an overall higher weight than each individual criterion alone.

FIG. 4 is a flow diagram showing a method 150 for the parimutuel wagering system according to embodiments of the present disclosure. The method 150 pertains to a multi-totalizer system whereby wagers are distributed to a totalizer from among two or more available totalizers based on one or more criteria. At 152 the system initiates. At 154 the wagers are received through a counter at a physical location or through an electronic device such as a smart phone, computer, tablet, or a gaming terminal. At 156 criteria for grouping wagers are received. At 158 the criteria are applied to the wagers, resulting in a selection of wagers for a given totalizer. At 160 the totalizer is selected for the wagers. At 162 the wagers are finalized and sent to the totalizer. At 164 the game or event that is the subject of the wagers takes place. The wagers are executed at 166 and payouts are given. This method 150 represents a seamless experience for the bettor. There is no risk of “totalizer shopping” which is the act of searching for an advantage based on a selection of totalizer. The bettor may never know that there are different totalizers, much less to which totalizer the wager was sent.

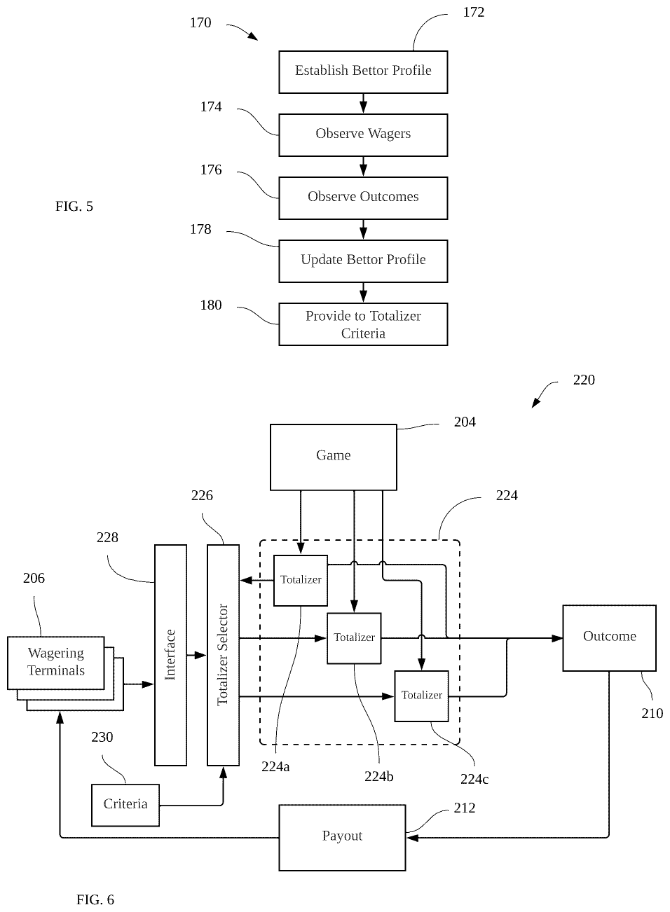

FIG. 5 is a flow diagram showing a method 170 for tracking a better profile according to embodiments of the present disclosure. At 172 a bettor profile is established after at least one interaction with the bettor. The bettor can be invited to create a profile with a username and password that is used to log into future games and wagers. At 174 wagers and other activities of the bettor are observed. At 176 outcomes of the game(s) upon which the bettor has placed a wager are observed. At 178 the bettor profile is updated with the outcomes and the wagers. At 180 the bettor profile is used by a totalizer selector to group wagers from the bettor with other bettors in an advantageous way.

FIG. 6 is a block diagram of a parimutuel wagering system 220 according to embodiments of the present disclosure. The system 220 performs parimutuel wagering for a wagering event or a series of wagering events 204, which may be a game, a race, a sporting event, a set of multiple games or races, historical events or races, or any other event or game that can be the subject of a parimutuel-style wager, whether traditional parimutuel wagering events or otherwise. The system 220 can be operated by a provider which may or may not be affiliated with the game 204. The system 220 of the present disclosure differs from prior art systems in that there are multiple totalizers 224a, 224b, and 224c (collectively totalizers 224) and a totalizer selector 226. Wagers 206 are directed to the different totalizers 224 based on established criteria. For the purposes of explanation and not limitation there are three totalizers in this system; however, it is to be appreciated that any number of totalizers can be used. The system 220 includes criteria 230 that are used to select which totalizer the wager 206 is to be directed.

The system 220 also includes a totalizer selector 226 that implements the criteria 230 based on a variety of factors. The system 220 also includes an interface 228 that receives the wagers 206 and enables the bettors placing the wagers 206 to have a seamless experience in the parimutuel wagering system. The interface 228 can be a graphical user interface (GUI) that enables wagers 206 to be placed on the game 204 including choice of competitor, finish, and wager. The interface 228 can also be equipped to perform financial transactions over electronic communication means such as the internet or a cellular network. The system 220 can be operated by a provider, and when the game dictates, a payout 212 can be made to the bettors placing the wagers 206. In some embodiments the game 204 is not affiliated with the provider or the system 220 at all; rather, the game 204 can be an independent event that is observed and monitored by the system 220.

Distributing the wagers 206 to different totalizers 224 has several benefits including but not limited to faster calculations due to the tote 224 having fewer calculations to perform. Having multiple totalizers can reduce the workload of each individual totalizer. Having multiple totalizers 224 allows for redundance in the event of a failure. Multiple totalizers can also result in a more modular system. There are many other benefits that will become clear from this disclosure.

The present disclosure includes various computing devices that carry out the wagering systems disclosed herein. There are wagering terminals, servers that may house the totalizers, there are network devices such as switches, cables, wireless transmitters, etc. There are various configurations of these computing devices that are within the scope of the present disclosure. Some of these computing devices may be virtual, and some may be hard wired. Some of the functionality and computations may be performed by one or several machines that may be in the same location or remote. Some of these computations may be executed over an internal bus, a wired network in a physical location, or over a wireless network such as the internet. For example, for some systems each totalizer is housed separately and may even be operated by different entities. In other systems multiple totalizers may be executed on a single machine.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for case of explanation only and are not meant to be limiting.

Although this disclosure describes certain exemplary embodiments and examples of a gaming or wagering system and related methods and devices, it will be understood by those skilled in the art that the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1. A parimutuel or pot-based wagering system, comprising: a first totalizer configured to perform parimutuel calculations according to a first pool; a second totalizer configured to perform parimutuel calculations according to a second pool; one or more wagering terminals; and a totalizer selector, comprising a processor and a memory storing one or more rules, wherein the totalizer selector is configured to communicate with the one or more wagering terminals, the first totalizer, the second totalizer, or another device having information regarding criteria to be used in totalizer selection, wherein the totalizer selector is configured to apply the one or more rules to a totalizer selection criteria, and wherein, based on the totalizer selection criteria and the one or more rules, the totalizer selector is configured to select the first totalizer or the second totalizer for a wagering event presented by one of the one or more wagering terminal, and output an indication of the selected first totalizer or the second totalizer to the one or more wagering terminals, the first totalizer, the second totalizer, or another device.

2. The parimutuel or pot-based wagering system of any one or combination of one or more of 1 above and 3-17 below, wherein the criteria are received from the one or more wagering terminals

3. The parimutuel or pot-based wagering system of any one or combination of one or more of 1-2 above and 4-17 below, wherein the criteria are received from the first totalizer or the second totalizer.

4. The parimutuel or pot-based wagering system of any one or combination of one or more of 1-3 above and 5-17 below, wherein the criteria are stored on memory of the totalizer selector or communicated to the totalizer selector from a memory of another device.

5. The parimutuel or pot-based wagering system of any one or combination of one or more of 1-4 above and 6-14 below, wherein the criteria comprise game characteristics.

6. The parimutuel or pot-based wagering system of any one or combination of one or more of 1-5 above and 7-17 below, wherein the criteria comprise wager characteristics.

7. The parimutuel or pot-based wagering system of any one or combination of one or more of claim 1-6 above and 8-17 below, wherein the criteria comprise bettor characteristics, wherein the bettor places the wagers received.

8. The parimutuel or pot-based wagering system of any one or combination of one or more of 1-7 above and 9-17 below, wherein the criteria comprise collective wager characteristics.

9. The parimutuel or pot-based wagering system of any one or combination of one or more of 1-8 above and 10-17 below, wherein the criteria comprise totalizer characteristics.

10. The parimutuel or pot-based wagering system of any one or combination of one or more of 1-9 above and 11-17 below, further comprising an interface configured to receive wagers from one or more bettors.

11. The parimutuel or pot-based wagering system of any one or combination of one or more of 1-10 above and 12-17 below, wherein the game characteristics comprise one or more of a game theme, game rules, and jurisdictional characteristics.

12. The parimutuel or pot-based wagering system of any one or combination of one or more of 1-11 above and 13-17 below, wherein the wager characteristics comprise denomination, tax consequences for the wagers, and jurisdictional characteristics pertaining to the wagers.

13. The parimutuel or pot-based wagering system of any one or combination of one or more of 1-12 above and 14-17 below, wherein the bettor characteristics comprise one or more of a profile for individual bettors, wherein the bettor profile is stored in the totalizer selector, and wherein the bettor profile is updated from time to time based, at least in part, upon one or more of bettor history and bettor outcomes.

14. The parimutuel or pot-based wagering system of any one or combination of one or more of 1-13 above and 15-17 below, wherein the bettor characteristics comprise characteristics of a group of bettors.

15. The parimutuel or pot-based wagering system of any one or combination of one or more of 1-14 above and 16-17 below, wherein the collective wager characteristics comprise one or more of odds, pool, and number of bettors.

16. The parimutuel or pot-based wagering system of any one or combination of one or more of 1-15 above and 17 below, wherein the totalizer characteristics comprise one or more of workload for the totalizers, reliability of the totalizers, and redundancy of the totalizers.

17. The parimutuel or pot-based wagering system of any one or combination of one or more of 1-17 above, wherein the wager characteristics comprise one or more ranges of wager amounts.

18. A computer-readable medium for a parimutuel or pot-based wagering system comprising storage containing instructions that, when executed by a processor, cause the parimutuel wagering system to perform a method, the method comprising: receiving one or more wagers from one or more bettors; receiving one or more criteria pertaining to totalizer selection, wherein the parimutuel wagering system comprises two or more totalizers configured to perform parimutuel wagering calculations or parimutuel-like wagering calculations based on the wagers received from the bettors, and based on a game that is the subject of the parimutuel wagering system; applying the criteria to the wagers to select a totalizer from among the two or more totalizers of the parimutuel wagering system to which the wagers are assigned; distributing the wagers to a corresponding totalizer based, at least in part, upon the criteria; monitoring the game; calculating an outcome of the wagers with respect to the game; and delivering a payout corresponding to the outcomes and the wagers according to the calculations of a totalizer.

19. The computer-readable medium of claim 15 wherein the criteria comprise one or more of game characteristics, wager characteristics, bettor characteristics, collective wager characteristics, and totalizer characteristics.

20. The computer-readable medium of claim 15, the system further comprising a wager receiving interface configured to parse wagers according to the criteria.

21. A parimutuel or pot-based wagering system, comprising: a processor; a memory storing instructions that, when executed by the processor cause the parimutuel wagering system to perform steps, the steps comprising: receiving a plurality of wagers on a game; storing one or more criteria for the wagers, the criteria determining a selection of a totalizer from among two or more totalizers configured to calculate the outcome of the game and the wagers; applying the criteria to the plurality of wagers; distributing the wagers to a corresponding totalizer according to the criteria; and calculating an outcome for each wager at the corresponding totalizer.

22. The parimutuel wagering system of claim 21, wherein the criteria one or more of game characteristics, wager characteristics, bettor characteristics, collective wager characteristics, and totalizer characteristics.

23. The parimutuel or pot-based wagering system according to one or a combination of one or more of 21-22, wherein the two or more totalizers are operated by a single entity.

24. The parimutuel or pot-based wagering system according to one or a combination of one or more of 21-23, wherein the game is not affiliated with the parimutuel wagering system.

25. The parimutuel or pot-based wagering system according to one or a combination of one or more of claim 21-24, wherein the criteria have a weighted average such that criteria with a higher assigned weight are more influential in a selection of totalizer.

26. A parimutuel or pot-based wagering system, comprising: a processor; a memory storing instructions that, when executed by the processor cause the parimutuel wagering system to perform acts comprising: communicating with one or more totalizers, wherein the totalizers are configured to perform calculations for one or more parimutuel games, each having a pool and wagers received from bettors; storing one or more criteria for assigning wagers to the totalizers; receiving a wager; and assigning the wager to a totalizer selected based, at least in part, upon the criteria.

27. A wagering terminal for a parimutuel game, the wagering terminal comprising: a display interface configured to display information to a bettor, the information relating to the parimutuel game, wagers on the parimutuel game, and outcomes of the parimutuel game; an input interface configured to receive inputs from the bettor including a selection of a game and a wager on the game; and an electronic communication interface configured to transmit the information and the inputs to and from the wagering terminal to a totalizer selector, the totalizer selector being in communication with one or more totalizers that are configured to perform calculations for the parimutuel game.

28. The wagering terminal of claim 27, wherein the totalizer selector is configured to assign the wager to one or more of the totalizers based on predetermined criteria.

29. The wagering terminal of claim 27 and/or claim 28, wherein the inputs comprise characteristics that pertain to the criteria used by the totalizer selector to assign the wager to a totalizer.

30. A totalizer for a parimutuel or pot-based wagering system, the totalizer comprising: a processor; a memory configured to store instructions that, when executed by the processor, cause the totalizer to perform acts, comprising: communicating electronically with a game, the outcome of which is the subject of wagers; communicating electronically with a totalizer selector configured to assign wagers on the game to the totalizer based, at least in part, upon criteria; receiving one or more wagers on the game from the totalizer selector, that are assigned to the totalizer, the wagers satisfying the criteria as determined by the totalizer selector; performing parimutuel calculations on the game and the wagers; and transmitting an outcome of the wagers.

31. A totalizer selector for a parimutuel or pot-based wagering system, the wagering system comprising a first totalizer configured to perform parimutuel calculations according to a first pool, a second totalizer configured to perform parimutuel calculations according to a second pool, and one or more wagering terminals, the totalizer selector comprising: a processor, and a memory storage, wherein the totalizer selector is configured to communicate with the one or more wagering terminals, the first totalizer, the second totalizer, or another device having information regarding criteria to be used in totalizer selection, wherein the totalizer selector is configured to apply the one or more rules to a totalizer selection criteria, and wherein, based on the totalizer selection criteria and the one or more rules, the totalizer selector is configured to select the first totalizer or the second totalizer for a wagering event presented by one of the one or more wagering terminal, and output an indication of the selected first totalizer or the second totalizer to the one or more wagering terminals, the first totalizer, the second totalizer, or another device.

32. The totalizer selector of any one or a combination of one or more of claim 31 above and 33-47 below, wherein the criteria are received from the one or more wagering terminals

33. The totalizer selector of any one or a combination of one or more of 31-32 above and 34-47 below, wherein the criteria are received from the first totalizer or the second totalizer.

34. The totalizer selector of any one or a combination of one or more of 31-33 and 35-47 below, wherein the criteria are stored on memory of the totalizer selector or communicated to the totalizer selector from a memory of another device.

35. The totalizer selector of any one or combination of one or more of 31-34 above and 36-47 below, wherein the criteria comprise game characteristics.

36. The totalizer selector of any one or a combination of one or more of 31-35 above and 37-47 below, wherein the criteria comprise wager characteristics.

37. The totalizer selector of any one or a combination of one or more of claim 31-36 above and 38-47 below, wherein the criteria comprise bettor characteristics, wherein the bettor places the wagers received.

38. The totalizer selector of any one or a combination of one or more of 31-37 above and 39-47 below, wherein the criteria comprise collective wager characteristics.

39. The totalizer selector of any one or a combination of one or more of 31-38 above and 40-47 below, wherein the criteria comprise totalizer characteristics.

40. The totalizer selector of any one or a combination of one or more of 31-39 above and 41-47 below, further comprising an interface configured to receive wagers from one or more bettors.

41. The totalizer selector of any one or a combination of any one or combination of one or more of 31-40 above and 42-47 below, wherein the game characteristics comprise one or more of a game theme, game rules, and jurisdictional characteristics.

42. The totalizer selector of any one or a combination of any one or combination of one or more of 31-41 above and 43-47 below, wherein the wager characteristics comprise denomination, tax consequences for the wagers, and jurisdictional characteristics pertaining to the wagers.

43. The totalizer selector of any one or a combination of any one or combination of one or more of 31-43 above and 14-47 below, wherein the bettor characteristics comprise one or more of a profile for individual bettors, wherein the bettor profile is stored in the totalizer selector, and wherein the bettor profile is updated from time to time based, at least in part, upon one or more of bettor history and bettor outcomes.

44. The totalizer selector of any one or a combination of any one or combination of one or more of 31-43 above and 45-47 below, wherein the bettor characteristics comprise characteristics of a group of bettors.

45. The totalizer selector of any one or a combination of any one or combination of one or more of 31-44 above and 46-47 below, wherein the collective wager characteristics comprise one or more of odds, pool, and number of bettors.

46. The totalizer selector of any one or a combination of any one or combination of one or more of 31-45 above and 47 below, wherein the totalizer characteristics comprise one or more of workload for the totalizers, reliability of the totalizers, and redundancy of the totalizers.

47. The totalizer selector of any one or a combination of any one or combination of one or more of 31-47 above, wherein the wager characteristics comprise one or more ranges of wager amounts.

1. A parimutuel or pot-based wagering system, comprising:
a first totalizer configured to perform parimutuel calculations according to a first pool;
a second totalizer configured to perform parimutuel calculations according to a second pool;
one or more wagering terminals; and
a totalizer selector, comprising a processor and a memory storing one or more rules,
wherein the totalizer selector is configured to communicate with the one or more wagering terminals, the first totalizer, the second totalizer, or another device having information regarding criteria to be used in totalizer selection,
wherein the totalizer selector is configured to apply the one or more rules to a totalizer selection criteria, and
wherein, based on the totalizer selection criteria and the one or more rules, the totalizer selector is configured to select the first totalizer or the second totalizer for a wagering event presented by one of the one or more wagering terminal, and output an indication of the selected first totalizer or the second totalizer to the one or more wagering terminals, the first totalizer, the second totalizer, or another device.

2. The parimutuel or pot-based wagering system according to claim 1, wherein the criteria are received from the one or more wagering terminals.

3. The parimutuel or pot-based wagering system according to claim 1, wherein the criteria are received from the first totalizer or the second totalizer.

4. The parimutuel or pot-based wagering system according to claim 1, wherein the criteria are stored on memory of the totalizer selector or communicated to the totalizer selector from a memory of another device.

5. The parimutuel or pot-based wagering system according to claim 1, wherein the criteria comprise game characteristics.

6. The parimutuel or pot-based wagering system according to claim 5, wherein the game characteristics comprise one or more of a game theme, game rules, and jurisdictional characteristics.

7. The parimutuel or pot-based wagering system according to claim 1, wherein the criteria comprise wager characteristics.

8. The parimutuel or pot-based wagering system according to claim 7, wherein the wager characteristics comprise denomination, tax consequences for the wagers, and jurisdictional characteristics pertaining to the wagers, or wherein the wager characteristics comprise one or more ranges of wager amounts.

9. The parimutuel or pot-based wagering system according to claim 1, wherein the criteria comprise bettor characteristics, wherein the bettor places the wagers received.

10. The parimutuel or pot-based wagering system according to claim 9, wherein the bettor characteristics comprise one or more of a profile for individual bettors, wherein the bettor profile is stored in the totalizer selector, and wherein the bettor profile is updated from time to time based, at least in part, upon one or more of bettor history and bettor outcomes, or wherein the bettor characteristics comprise characteristics of a group of bettors.

11. The parimutuel or pot-based wagering system according to claim 1, wherein the criteria comprise collective wager characteristics.

12. The parimutuel or pot-based wagering system according to claim 11, wherein the collective wager characteristics comprise one or more of odds, pool, and number of bettors.

13. The parimutuel or pot-based wagering system according to claim 1, wherein the criteria comprise totalizer characteristics.

14. The parimutuel or pot-based wagering system according to claim 13, wherein the totalizer characteristics comprise one or more of workload for the totalizers, reliability of the totalizers, and redundancy of the totalizers.

15. A computer-readable medium for a parimutuel or pot-based wagering system comprising storage containing instructions that, when executed by a processor, cause the parimutuel wagering system to perform a method, the method comprising:
receiving one or more wagers from one or more bettors;
receiving one or more criteria pertaining to totalizer selection, wherein the parimutuel wagering system comprises two or more totalizers configured to perform parimutuel wagering calculations or parimutuel-like wagering calculations based on the wagers received from the bettors, and based on a game that is the subject of the parimutuel wagering system;
applying the criteria to the wagers to select a totalizer from among the two or more totalizers of the parimutuel wagering system to which the wagers are assigned;
distributing the wagers to a corresponding totalizer based, at least in part, upon the criteria;
monitoring the game;
calculating an outcome of the wagers with respect to the game; and
delivering a payout corresponding to the outcomes and the wagers according to the calculations of a totalizer.

16. A totalizer selector for a parimutuel or pot-based wagering system, the wagering system comprising a first totalizer configured to perform parimutuel calculations according to a first pool, a second totalizer configured to perform parimutuel calculations according to a second pool, and one or more wagering terminals, the totalizer selector comprising:
a processor, and
a memory storage,
wherein the totalizer selector is configured to communicate with the one or more wagering terminals, the first totalizer, the second totalizer, or another device having information regarding criteria to be used in totalizer selection,
wherein the totalizer selector is configured to apply the one or more rules to a totalizer selection criteria, and
wherein, based on the totalizer selection criteria and the one or more rules, the totalizer selector is configured to select the first totalizer or the second totalizer for a wagering event presented by one of the one or more wagering terminal, and output an indication of the selected first totalizer or the second totalizer to the one or more wagering terminals, the first totalizer, the second totalizer, or another device.

17. The totalizer selector according to claim 16, wherein the totalizer selector is configured to receive the totalizer selection criteria from the one or more wagering terminals.

18. The totalizer selector according to claim 16, wherein the criteria are received from the first totalizer or the second totalizer.

19. The totalizer selector according to claim 16, wherein the criteria are stored on memory of the totalizer selector or communicated to the totalizer selector from a memory of another device.

20. The totalizer selector according to claim 16, wherein the criteria comprise game characteristics; wager characteristics; bettor characteristics, wherein the bettor places the wagers received; collective wager characteristics; and/or totalizer characteristics.
